(19) United States
(12) Patent Application Publication
(10) Pub. No.: US 2021/0155845 A1
(43) Pub. Date: May 27, 2021

(54) METHOD FOR REDUCING THE VISCOSITY OF HEAVY OIL FOR EXTRACTION, TRANSPORT IN PIPES, AND CLEANING THEREOF

(71) Applicant: University of Houston System, Houston, TX (US)

(72) Inventors: Zhifeng Ren, Pearland, TX (US); Dan Luo, Houston, TX (US)

(73) Assignee: University of Houston System, Houston, TX (US)

(21) Appl. No.: 17/102,155

(22) Filed: Nov. 23, 2020

Related U.S. Application Data
(60) Provisional application No. 62/939,169, filed on Nov. 22, 2019.

(51) Int. Cl. C09K 8/594; C09K 8/592; E21B 43/20

(52) U.S. Cl. CPC C09K 8/594; E21B 43/20; C09K 8/592

(57) ABSTRACT

A composition composed of highly reactive metal particles that are ball milled, bead milled or blended and dispersed in a solvent with/without polymer for significantly reducing the viscosity of heavy oil for extracting viscous heavy oil, such that the composition reacts with water and oil to produce heat, H₂ gas, and hydroxide to lower the oil viscosity and facilitate extraction from an underground formation or transport of heavy oil, such as in a pipe from one place to another place.

### CROSS-REFERENCE TO RELATED APPLICATIONS

The present application claims priority to U.S. Provisional Patent Application No. 62/939,169, filed Nov. 22, 2019, the entire contents of which is hereby incorporated herein by reference for all purposes.

### STATEMENT REGARDING FEDERALLY SPONSORED RESEARCH OR DEVELOPMENT

N/A

### BACKGROUND

### Field of the Disclosure

The disclosure relates to viscosity reduction of a hydrocarbon, wherein the reduction in viscosity of the hydrocarbon may aid in the extraction, removal, or transport of the hydrocarbon. The disclosure more particularly relates to reducing the viscosity of an oil, wherein the oil may be, but not limited to heavy oil and extracting for example underground viscous heavy oil, the transportation thereof by long distance pipes, and cleaning of such oil. The disclosure also relates to viscosity reduction of oil sands, light sweet crude, and shale oil. The disclosure particularly relates to compositions comprising highly reactive metal, oxides, and salt particles that react with water and oil to produce large amounts of alkaline, gas, and heat for reducing the viscosity of, for example heavy oil and aid in the recovery of oil from: underground formations, above ground oil-sands, its transport through pipes, and methods of making and using the same.

### Background of the Disclosure

Employing nanotechnology for enhanced oil recovery (EOR) is believed to provide revolutionary “green” or “zero emissions” solutions to previously intractable problems in the oil and gas industry. Nanotechnology has been envisioned to transform the petroleum industry. Numerous research on nano-EOR have been done in the past few years and shown promising results for improving oil recovery. Injected nanoparticles and/or nanosheets are believed to be able to form adsorption layers on the top of the grain surface. The adsorptions layers then alter the wettability of the rock and reduce the interfacial tension. Thus, the adsorption of nanoparticles and/or nanosheets is one of the important aspects that needs to be understood for a successful EOR implementation. Various types of nanoparticles and/or nanosheets can improve oil recovery through several mechanisms such as wettability alteration, interfacial tension reduction, disjoining pressure and mobility control. Parameters such as salinity, temperature, size, and concentration are substantial for nano-EOR. Nanoparticles and/or nanosheets can improve the oil recovery significantly after the primary recovery period.

As projected by the Organization of the Petroleum Exporting Countries (OPEC) in 2019, the expected global oil demand will increase to 110.6 million barrels per day in 2040. As reserves of conventional light oil become depleted, recovery of viscous oil is urgently needed to meet increasing energy demands worldwide. Hydrocarbon or fossil fuel plays a major role in today's human civilization. During industrialization era coal was the dominant source, until today oil and gas are the major fuel for all transportation sectors. Hydrocarbon is still predicted to be the primary source of energy for the upcoming decades, and the consumption of hydrocarbon will significantly increase over the years. However, there are numerous oil and gas fields in the world which have already reached plateau period and the production will likely decline. To meet the energy demand for the next decades, methods for extracting residual hydrocarbon trapped in reservoir need to be developed economically. Based on U.S Department of Energy data, 67% of total oil in the United States of America will remain in the reservoir because of the limitation of the technology to extract residual hydrocarbon. There are various enhanced oil recovery (EOR) technologies which have been applied and were proven to increase hydrocarbon recovery significantly such as thermal methods, miscible methods, chemical methods, as well as some new technologies (microbial, low salinity flooding). More recently, nanotechnology is proposed to be one of the promising EOR methods since it can penetrate the pore throat easily and change the reservoir properties to increase the oil recovery. Nanotechnology has shown its potential to revolutionize the petroleum industry for both upstream and downstream sectors in the recent years.

As the molecular structure of oil becomes more complex, the oil becomes heavier and more viscous, causing flow problems at regular reservoir conditions and exhibiting strong temperature-dependent behavior. Due to the variety of both the heavy oil viscosities and the reservoir locations around the world, different recovery technologies must be applied. Current state-of-the-art technologies fall into two categories, surface mining and in situ recovery. Surface mining refers to the mining of oil sands on land, followed by extraction of the oil through dilution with n-pentane or n-heptane. Although this method has been used for decades, there are increasing concerns regarding disposal of tailings, water consumption, etc.

Since most heavy oil resources are in the subsurface, much greater attention has been focused on in situ recovery methods by both industry and academic researchers. In recent years, both non-thermal and thermal methods have been developed, with respective advantages and disadvantages. Generally, the non-thermal methods, including cold production with sands, vapor extraction (VAPEX), chemical injection, miscible flooding, etc., can be used for thin layers of formation, but are limited to such shallow formation and to relatively light (<200 cP) viscous oils. Although thermal methods like in situ combustion, steam flooding, cyclic steam stimulation, etc., can achieve a higher recovery factor for more viscous oil, especially steam-assisted gravity drainage (SAGD) with a potential recovery factor of more than 70%, they have the strict requirement of thick formation for economic production, and their economic feasibility also largely depends on the market oil price. In addition, to produce the steam required for these thermal methods, fuel must be consumed, such as by burning natural gas, resulting in considerable CO₂ emissions. Therefore, seeking alternative techniques to overcome the limitations mentioned above is of great importance (see: Guo, K.; Li, H. L.; Yu, Z. X., In-situ heavy and extra-heavy oil recovery: A review, Fuel 185, 886-902 (2014), Istchenko, C. M.; Gates, I. D., SPE Journal 19, 260-269 (2014); Ahmadi, M. A.; Zendehboudi, S.; Bahadori, A.; James, L.; Lohi, A.; Elkamel, A.; Chatzis, I., Ind. Eng. Chem. Res. 53, 16091-16106 (2014). Ahmadi, M.; Chen, Z. X., Adv. Colloid Interface Sci. 275, 102081 (2020); Orr Jr. F. M.; Taber, J. J., Science 224, 563-569 (1984); Chopra, S.; Lines, L.; Schmitt, D. R.; Batzle, M., Heavy-Oil Reservoirs: Their Characterization and Production,” Geophysical Developments Series: 1-69 (2010); Biyouki, A. A.; Hosseinpour, N.; Nassar, N. N., Energy Fuels 32, 5033-5044 (2018); Sun, F. R.; Yao, Y. D.; Chen, M. Q.; Li, X. F.; Zhao, L.; Meng, Y.; Sun, Z.; Zhang, T.; Feng, D., Energy 125, 795-804 (2017); Wang, Y. Y.; Zhang, L.; Deng, J. Y.; Wang, Y. T.; Ren, S. R.; Hu, C. H., J. Petrol. Sci. Eng. 151, 254-263 (2017); Mukhametshina, A.; Kar, T.; Hascakir, B., SPE Journal, 21, 380-392 (2016)). Current technologies thus suffer from low efficiency, high cost, and environmental concerns, as well as the requirement of strict formation conditions, and further attempts to use nanotechnology in oil extraction have thus far been recognized to have only auxiliary effects, such as in modifying the crude oil's rheology and serving as catalysts to upgrade the crude oil during the steam process (see: Taborda, E. A.; Franco, C. A.; Ruiz, M. A.; Alvarado, V.; Cortes, F. B., Energy Fuels 31, 1329-1338 (2017); Saha, R.; Uppaluri, R. V. S.; Tiwari, P., Ind. Eng. Chem. Res. 57, 6364-6376 (2018); Alade, 0. S.; Shehri, D. A. A.; Mahmoud, M., Pet. Sci. 16, 1374-1386 (2019); Wang, D. R.; Xu, L.; Wu, P., J. Mater. Chem. A. 2, 15535-15545 (2014); Lin, D.; Feng, X.; Wu, Y. N.; Ding, B. D.; Lu, T.; Liu, Y. B.; Chen, X. B.; Chen, D.; Yang, C. H., Appl. Surf. Sci. 456, 140-146 (2018); and Yeletsky, P. M.; Zaikina, O. O.; Sosnin, G. A.; Kukushkin, R. G.; Yakovlev, V. A., Fuel Process. Technol. 199, 106239 (2020)).

Thus, large amounts of heavy oils are yet to be extracted, especially extra heavy oil and a method to extract underground heavy or extra heavy oil efficiently and economically is urgently needed. Disclosed herein is such a new method to reduce the viscosity of underground viscous heavy oil efficiently and economically for ease of extraction and addresses the above laid out shortfalls of conventional methods.

### BRIEF SUMMARY OF DISCLOSURE

Disclosed herein, in one embodiment is a composition for reducing the viscosity of oil, comprising: a reactive particle; a solvent and a polymer; and wherein the reactive particle is between 1 nm and 1000 microns in size and is dispersed within said solvent, and wherein the composition reacts with water and oil to lower oil viscosity and facilitate extraction from a body. In another embodiment a composition for reducing the viscosity of oil is disclosed wherein the composition comprises a reactive particle; and solvent and wherein the reactive particle is between 1 nm and 1000 microns in size and is dispersed within said solvent, and wherein the composition reacts with water and oil to lower oil viscosity and facilitate extraction from a body. In some embodiments the body is a hydrocarbon comprising formation, in other embodiment the body is man made, such as in pipes, or machinery, in some embodiments the body is above ground, in other embodiments the body is below ground. In one embodiment the body is an above ground sand-oil formation. In a further embodiment the body is one of: an oil well, a below ground oil well, or a deep oil well.

In some embodiments, the reactive particle comprises at least one of VO, Ni, Fe, Li, Na, K, Rb, Cs, Mg, Ca, Sr, Ba, B, Al, Ga, an oxide, sulfate, nitride, or phosphide thereof.

In one embodiment is a composition for reducing the viscosity of heavy oils for ease of extracting viscous heavy oil, comprising a reactive particle; a solvent; and/or a polymer; wherein the metal particle is between 1 nm and 1000 microns in size and is dispersed within the solvent, and wherein the composition reacts with water and oil to lower oil viscosity and facilitate extraction from an underground formation; wherein in some embodiments the reactive particle comprises at least one of VO, Ni, Fe, Li, Na, K, Rb, Cs, Mg, Ca, Sr, Ba, B, Al, Ga, an oxide, sulfate, nitride, or phosphide thereof; wherein in some further embodiments the reactive particle is a size reduced particle wherein the particle is reduced in size by a mechanic method, wherein the mechanical method is ball milling, or blending. In other embodiments of the composition disclosed herein, the solvent is selected from silicone oil, hexane, heptane, toluene, liquid wax, or any organic solvent which can prevent the particles from contact with water and oxygen; wherein in some other embodiments the polymer is a hydrophobic polymer, and wherein the polymer stabilizes the reactive particle dispersed within the solvent; wherein in some embodiments the polymer can has a melting point of about 50° C., and in a further embodiment the polymer is low viscous engine oil.

In another embodiment, disclosed herein is a method of making a composition for reacting with viscous heavy oil; ball milling or blending a metal particle and producing metal particles, wherein the ball milled, bead milled or blended metal particles are between 1 nm and 1000 microns in size; dispersing the ball milled, bead milled or blended metal particles in a solvent and forming a dispersion; and mixing a polymer with the dispersion to form a polymer stabilized dispersion. In a further embodiment, disclosed herein is a method of reducing the viscosity of heavy oil comprising: adding a composition comprising a highly reactive metal particle; a solvent; and a polymer to an oil of a first viscosity; reacting the composition within the oil and reducing the viscosity of the oil to produce an oil with a lower viscosity. In still further embodiment, disclosed herein is a method of extracting oil from a formation comprising adding a composition comprising a highly reactive metal particle; a solvent; and a polymer to a formation comprising an oil of a first viscosity; reacting the composition within the oil and reducing the viscosity of the oil to produce an oil with a lower viscosity, and extracting the oil with the lower viscosity from the formation; wherein in some embodiments the oil is heavy or extra heavy oil; wherein the highly reactive metal particle is ball milled, bead milled or blended, and is between 1 nm and 1000 microns in size; and wherein in other embodiments the method is scalable and economical.

In some embodiments of the method disclosed herein the composition is injected into an oil well or underground formation comprising oil or oil transport pipe; in other embodiments the reacting further comprises reacting with water comprised within the formation, and wherein the reaction is exothermic and reduces the viscosity of the oil; in some other embodiments of the method disclosed herein reacting further comprises the formation of metal hydroxides which further react with organic acids comprising in the heavy oil, and forming in situ surfactants, wherein the surfactant lower oil/water interfacial tension to form an emulsion; in some further embodiments of the method disclosed herein reacting further comprises the formation of hydrogen gas in-situ in the oil well, which may be benefit for increasing reservoir energy, cause a viscosity reduction by the miscible with heavy oil, and upgrade oil quality by inducing hydrogenation reactions, and in some still further embodiments of the method disclosed herein the polymer comprising the composition acts as a dispersant of the particles in order to reduce the viscosity of the heavy oil comprising the well formation, and in other embodiments of the method, adding is by injection, or under pressure, and wherein the adding may occur after an injection of water, or before an injection of water into the well or formation.

In another embodiment a method of making a sodium nanofluid is disclosed, the method comprising a first mixing of a sodium metal and silicone oil, wherein the first mixing is for a first time (T1) at a first speed (S1), followed by a second mixing of said metal and oil for a second time (T2) at a second speed (S2), wherein the first mixing the second mixing is by a mechanical shear force; and wherein S1<S2, and T1<T2, wherein the first followed by the second mixing form a sodium nanofluid, and wherein the sodium nanofluid is cooled at five minute intervals during each of the first mixing and said second mixing. In some embodiments T1 may be one of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 45, 60 minutes; and in some embodiments T2 may be one of about 2, 3, 4, 5, 6, 7, 8, 8, 10, 11, 12, 13, 14, 15, 16, 17, 18, 19, 20, 21, 22, 23, 24, 25, 26, 27, 28, 29, 30, 45, or 60 minutes. In a further embodiment S1 may be 10, 20, 30, 40, 50, 60, 70, 80, 90, 100, 150, 200, 250, 300, 350, 400, 50, 1000, 10000, or 100000 rpm; and S2 may be one of 11, 20, 30, 40, 50, 60, 70, 80, 90, 100, 150, 200, 250, 300, 350, 400, 50, 1000, 10000, or 100000 rpm.

### BRIEF DESCRIPTION OF THE DRAWINGS

FIG. 1 depicts: a) ball milled, bead milled or blended sodium Metal in an embodiment of a liquid, such as silicone oil, engine oil, or mineral oil, or vegetable oil, or liquid wax, or any other liquid; b) an image showing reduced size of sodium metal particles of an exemplary embodiment of the present disclosure;

FIG. 2 depicts separation of sodium from silicone oil, or engine oil of an exemplary embodiment of the present disclosure, wherein separation occurred by centrifugation;

FIG. 3 depicts sodium particles dispersed in organic solvent in an exemplary embodiment of the present disclosure;

FIG. 4 depicts extra heavy oil as used in embodiments described herein;

FIG. 5 depicts extra heavy oil viscosity reduction tests at room temperature of an exemplary embodiment of the present disclosure;

FIG. 6 depicts a comparative study of extra heavy oil viscosity reduction tests at room temperature of an exemplary embodiment of the present disclosure;

FIG. 7 depicts: a) a schematic of sodium nanosheets produced using a household blender by for example by mixing in silicone oil; b) a visual stability evaluation at 25° C. in silicone oil and in a mixture of silicone oil and kerosene; c) a depiction of test-dependent XRD measurements of synthesized sodium nanosheets in silicone oil; d) an AFM image of synthesized sodium nanosheets in silicone oil with height profiles at three different positions; and e) distribution of hydrodynamic diameters of the sodium nanofluid detected by a light scattering method;

FIG. 8 depicts: a) an image of the extra-heavy oil; b) a frequency-dependent loss modulus, storage modulus, and complex viscosity of the extra-heavy oil measured at 25° C. by a rotational rheometer; b) a schematic illustration of the sand-pack flow apparatus, and sodium nanofluid is used to recover the extra-heavy oil, which is initially mixed with zirconium oxide balls and packed as a column 7 cm long with a 2.765 cm diameter;

FIG. 9 depicts: a) an initial temperature of 1 gram of extra-heavy oil mixed with 40 mg of sodium nanosheets dispersed in 0.5 mL kerosene; b) the maximum temperature reached following reaction triggered by injection of 0.3 mL water in the same fluid system; c) the initial state of 1 gram of extra-heavy oil mixed with 40 mg sodium nanosheets dispersed in 0.2 mL kerosene/silicone oil (1:1 volume ratio); and d,) shows the injection of 0.2 mL water which causes the extra-heavy oil system to swell after a very short time;

FIG. 10 depicts the normalized ratio of maximum sodium peak to the maximum sodium hydroxide peak for different rounds of XRD testing. The normalization is based on the results of the first test round;

FIG. 11 depicts the surface color evolution of ZrO2 balls after three stages of sodium nanofluid injections;

FIG. 12 depicts: a) a fluid systems of 1 gram of extra-heavy oil mixed with 10 mL water and different concentrations of sodium nanosheets dispersed in 0.5 mL kerosene/silicone oil (1:1 volume ratio); b) a magnified image of the dashed red box in a obtained by an optical microscope, wherein the inset depicts the emulsion type that was determined by injecting several drops of emulsion into kerosene; and c) depicts the demulsification of the fluid system using 40 mg sodium nanosheets and its viscosity at 25° C.

### DETAILED DESCRIPTION OF DISCLOSED EXEMPLARY EMBODIMENTS

The following discussion is directed to various exemplary embodiments of the invention. However, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and that the scope of this disclosure, including the claims, is not limited to that embodiment.

The drawing figures are not necessarily to scale. Certain features and components herein may be shown exaggerated in scale or in somewhat schematic form and some details of conventional elements may be omitted in interest of clarity and conciseness.

As used herein, nanoparticles may comprise nanosheets. The nanoparticles may be irregular in shape, or regular in shape, or combinations thereof.

In the following discussion and in the claims, the terms “including” and “comprising” are used in an open-ended fashion, and thus should be interpreted to mean “including, but not limited to . . . .” As used herein, the term “about,” when used in conjunction with a percentage or other numerical amount, means plus or minus 10% of that percentage or other numerical amount. For example, the term “about 80%,” would encompass 80% plus or minus 8%. References cited herein are incorporated in their entirety by such reference.

Heavy oil is generally accepted as oil with high viscosity due to the larger proportion of high molecular weight constituents in comparison with conventional crude oil. More precisely, crude oil is classified into different types by using its American Petroleum Institute (API) values:

$$API = \frac{141.5}{SG} - 131.5$$

wherein SG is the ratio of oil density to water density.

For heavy crude oil, the API value is between 10 and 20. When the value is less than 10, the oil becomes extra heavy. The resources of heavy oil are abundant and comprises about five times that of the conventional oil reserves.

The nanomaterials disclosed herein are made by a simple, scalable, and inexpensive methods that may allow for surface transportation and injection; b) the nanomaterials are small enough for transport into rock pores without significant damage to the formation; c) the nanomaterial system has a high oil recovery factor and may result in a net profit; and d) the overall process from material synthesis to post-treatment may have a low environmental impact. Herein disclosed are examples of such nanomaterials, compositions thereof, and methods of using such nanomaterial compositions to lower solution viscosity, such as but not limited to the viscosity of oil, including heavy oil, and thus allow movement, and extraction of the same, through or from any body, particularly the extraction of heavy oil from a bed or rock formation.

One embodiment disclosed herein is drawn to making and dispersing highly reactive particles (ranging in size from nanometers to micrometers) in non-water and oxygen containing liquids, wherein the particles may also be wrapped in a low melting point polymer that will disassociate from the particles at above 50° C.; between 50° C. and 60° C.; between 60° C. and 70° C.; between 70° C. and 80° C.; between 80° C. and 90° C.; and between 90° C. and 100° C. These particles are made by milling one or more of Li, Na, K, Rb, Cs, Mg, Ca, Sr, Ba, B, Al, Ga, their oxides, or a further material such as salt such as Mg₂SO₄ (that may release a large amount of gas and heat when it encounters with water) into liquids of non-water and oxygen containing liquids such as a solution, an oil, a heavy oil, engine oil, mineral oil, vegetable oil, liquid wax, etc.

The particles, and methods described herein, in some embodiments may generate multiple effects on the heavy oil in situ, such as viscosity reduction and oil quality upgrading due to the in-situ generation of a large amount of hydrogen gas, heat, and induction of a basic environment.

In some embodiments, bulk metal or metal oxide or salt materials are firstly reduced to nanometer-micrometer in size in an environment without air and water, such as milling or blending in viscous oil like silicone oil, engine oil, mineral oil, vegetable oil, liquid wax, etc. for a time period of a few minutes to a few hours, such as between 5 minutes to 600 minutes, 10 minutes to 500 minutes, 20 minutes to 400 minutes, 30 minutes to 200 minutes, 45 minutes to 100 minutes, 60 minutes to 120 minutes; and 1 minute to 60 minutes.

After size reduction, high concentrations of particles are dispersed in solvents such as pentane, hexane, heptane, toluene, etc. These solvents may also reduce heavy oil viscosity. Meanwhile, polymer(s) may be added to form a core/shell structure in order to increase the colloidal stability and to delay reaction with water and thus may in some embodiments function as a protecting agent. The highly concentrated dispersion is then injected into reservoirs either with or in some embodiments, without a pre-injection of liquid to prevent the immediate reaction of the particles with existing water in the well. In another embodiment, additional water is then further injected into the reservoir to push the oil which now comprises a significantly reduced viscosity, to ground level.

The reactions between these metal or metal oxide or metal salt particles liberate three products: hydrogen, heat, and hydroxide, all of which, in some embodiments significantly reduce the viscosity of oil. Metal hydroxides such as NaOH, KOH, etc., when generated in-situ may react with organic acids comprised within heavy or extra heavy crude oil. In this way, surfactants are produced in situ which may lower the interfacial tension, benefiting in one embodiment the flow of oil from the rock bed. Furthermore, hydrogen gas generated in some embodiments may be miscible with heavy oil to also reduce the viscosity. Under certain other embodiments and conditions, hydrogen gas may react with the unsaturated components of heavy crude oil via hydrogenation reactions, which upgrades the quality of oil.

X+H₂O→XOH+H₂+heat, where X is a metal such as Li, Na, K, . . .

XO+H₂O→XOH+heat, where XO is metal oxide Li₂O, Na₂O, K₂O . . .

MgSO₄+H₂O—→MgSO₄.mH₂O+heat, where m can be in a range of 1 and 10

This method is facile to operate and also economic, as compared to current methods known in the art.

### EXAMPLES

One such example of the nanomaterial disclosed herein are sodium nanofluids. The sodium nanofluids disclosed herein display outstanding performance for extra-heavy oil recovery without additional heat input. In sand-pack experiments at room temperature, they were found to achieve a recovery factor of more than 80% for extra-heavy oil with viscosity of over 400,000 cP as received. A sodium nanofluid as disclosed herein in one embodiment was produced using a household blender, making its synthesis simple, fast, and inexpensive. In principle, the excellent recovery factor for extra-heavy oil is based on the reaction:

2Na+2H₂O→2NaOH+H₂.+heat

This reaction utilizes multiple industrial chemicals to release a substantial amount of heat, which may therefore reduce the viscosity of the heavy oil. Sodium metal in fact attacks the aromatic compounds in for example oil and forms electron donor-acceptor ion pairs, i.e., Na⁺[aromatic^{⋅}]⁺ or (Na⁺)₂[aromatic]²⁻, which are active for hydrogen exchange reactions (Styles, Y. P.; Klerk, A. D., Energy Fuels 30, 5214-5222 (2016)). Moreover, one of the reaction products, sodium hydroxide (NaOH), is the chemical commonly used for alkaline flooding in oil fields, while the other reaction product, hydrogen gas (H₂), may be further used in situ for gas flooding as well as for upgrading the heavy oil by a hydrogenation reaction when certain conditions are met (Gong, H. J.; Li, Y. J.; Dong, M. Z.; Ma, S. Z.; Liu, W. R., Colloids Surf. A 488, 28-35 (2016); Ramachandran, R.; Menon, R. K., Int. J. Hydrogen Energy 23, 593-598 (1998); Teschner, D.; Borsodi, J.; Wootsch, A.; Révay, Z.; Hävecker, M.; Knop-Gericke, A.; Jackson, S. D.; Schlögl, R., Science 320, 86-89 (2008)).

Furthermore, the reaction can be well controlled and initiated in situ as triggered following water injection, while the disappearance of the sodium nanomaterials after completion of the reaction eliminates the concern for permeability damage resulting from the adsorption and retention of nanomaterials.

Thus, in essence the high recovery performance is based the on reaction between sodium and water, which allows the nanofluid to exhibit multiple benefits in displacing subsurface oil. Substantial heat is released to raise the temperature for viscosity reduction. The generation of hydrogen gas helps to supply reservoir energy and to swell the heavy oil, as well as enabling possible oil miscibility and upgrading when certain criteria are met. Moreover, sodium hydroxide is produced to in situ synthesize surfactants for lowering interfacial tension and emulsification. Multi-stage nanofluid injection is found to be superior to a single-stage injection mode since the sweeping efficiency is improved.

### Example 1: Sodium Nanomaterial Preparation (Blending and Ball-Milling)

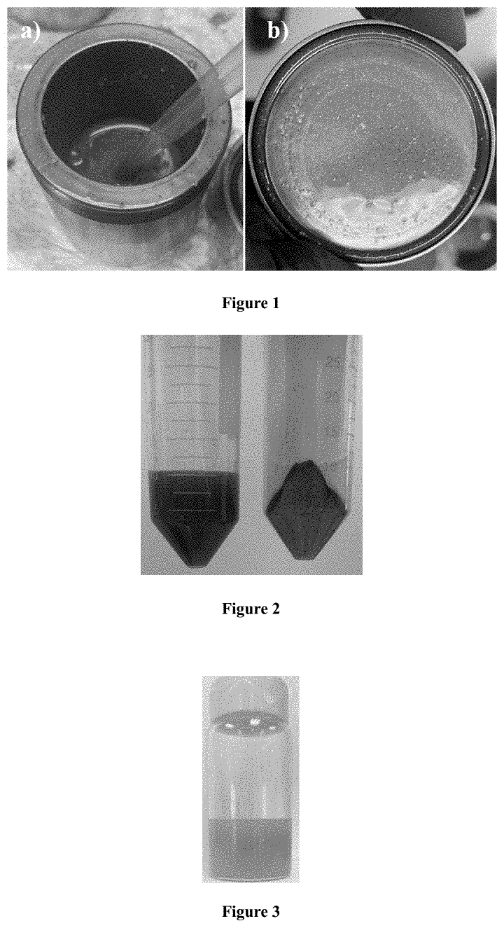

1 gram of sodium metal was transferred to a ball milling jar with 40 mL viscous engine oil in the glove box. After high energy ball milling for a few hours, the size of the sodium metal particle was reduced to nanometer-micrometer, as shown in FIG. 1. The sodium particles were protected by the oil to avoid reaction with air and moisture. In order to reuse the engine oil, centrifugation was employed to separate the sodium particles from the engine oil as shown in FIG. 2.

Similarly, 2 grams of sodium metal were placed in a blender with 100 mL of mineral oil. After 15 minutes of blending, the size of the sodium metal was reduced to nanometer-micrometer. The sodium particles are protected by the oil avoiding reaction with air and moisture.

An organic solvent (pentane/hexane) was then used to disperse the concentrated sodium metal particles as shown in FIG. 3. A hydrophobic polymer with high molecule weight may be added to the system for further stabilizing the dispersion of sodium particles and delaying the reaction with water.

After successful dispersion of the sodium metal particles, viscosity reduction experiments were performed. All experiments described herein were conducted at room temperature. The bottles were then placed in an oven at 65° C., which is comparable to the temperature of heavy oil wells.

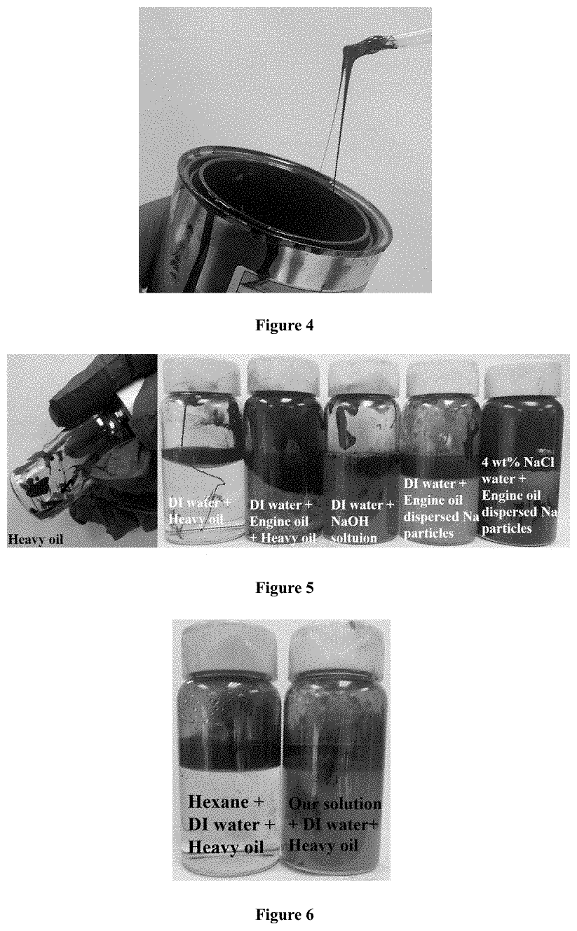

FIG. 4 shows an image of an original extra heavy oil. An extra heavy oil sample was used in a comparative study. As shown in FIG. 5, the original heavy oil from FIG. 4 is so sticky it could barely flow. Deionized (DI) water and the heavy oil were shaken together. The heavy oil stayed as a single piece. Due to the relatively lower density of heavy oil than water, after settlement the heavy oil floats on the water surface. Then, engine oil was mixed into heavy oil and DI in water bottle.

After shaking and settlement, the oil viscosity changes due to the miscible of low viscous engine oil in heavy oil. However, the viscous heavy oil still floats on the water surface. In another bottle, NaOH was added into the heavy oil in DI water followed by shaking, the organic acids in the heavy oil could react with NaOH, and thus in some embodiments may generate surfactants which emulsify oil and water as the unclear water phase indicates. However, most of the viscous heavy oil remained floating on the water surface. In comparison, a few drops of engine oil dispersed sodium particles were placed in the heavy oil and DI water bottle.

After treatment, the heavy oil becomes much more flowable and the emulsion is also produced as the yellow color in water phase indicates, and when the cap is opened, gas is released, wherein in some embodiments the air is H₂ and air that expanded under a higher temperature caused by the heat generated by the metal nano/micro particles. These observations indicate a reaction between the sodium particles and water which clearly helps to significantly reduce the viscosity of oil and improve flowability.

This process was repeated in a further embodiment, using saltwater conditions (e.g., 4 wt % NaCl water), and was found to aid extra heavy oil to flow, very similar to the case of DI water. To further compare the performance of pentane/hexane with the solution disclosed herein and as shown in FIG. 3, 1 mL pentane/hexane and the solution were separately added into two bottles which contain almost the same amount of heavy oil and DI water. As shown in FIG. 6, after treatment, the heavy oil may flow for both of the bottles, however, the bottle comprising the disclosed sodium particles flows much better, and clearly generates a milky-like emulsion which indicates the generation of surfactant by the reaction of NaOH with an acid group(s) comprising the heavy oil, and thus the formation of an in situ emulsion provides a benefit of this method for oil recovery. Gas was again detectable by ear, on opening of the sealed reaction bottle.

It was found that the oil treated as described herein, thus is much less viscous having a lower viscosity, hence the oil may be removed from the well formation with greater ease due to its improved flowability as a result of treatment with the particles and methods described herein.

Thus, demonstrated in some embodiments herein, is a method to reduce the viscosity of a solution, such as but not limited to: heavy oil, in a further embodiment a method of extracting a solution such as but not limited to: heavy oil, or extra heavy oil from an underground formation is disclosed. In a further embodiment a method of making nanometer-micrometer sized highly reactive metal particles wrapped in a polymer in an oil is disclosed, wherein the production of such particles is both scalable and economically viable.

In some embodiments, the particles may be easily injected into oil wells for reaction with water comprised within a well, and in some further embodiments the injection process may comprise one injection, or multiple injections.

The reaction with heavy oil comprising the well formation is highly exothermic (happens in situ (inside of) the well) and thus in other embodiments significantly increases the temperature so to reduce the viscosity of the heavy oil. As the heat is generated in situ when the composition meets with the oil/water, it is still effective in deep wells compared to compositions that react prior to being in situ of the formation.

In some other embodiments, the particle reaction with water in situ of the well further produces metal hydroxide which may further react with organic acids in the heavy oil, and thus generates in situ surfactants that lower oil/water interfacial tension.

In other embodiments, the metal particles may produce hydrogen gas in-situ (inside of) the well, which may be benefit for increasing reservoir energy, cause a viscosity reduction by the miscible with heavy oil, and upgrade oil quality by inducing hydrogenation reactions. Furthermore, in some embodiments the organic solvent used to disperse the high concentrated particles may also help to reduce the viscosity of the heavy oil comprising the well formation.

### Example 2: Sodium Nanofluid Production

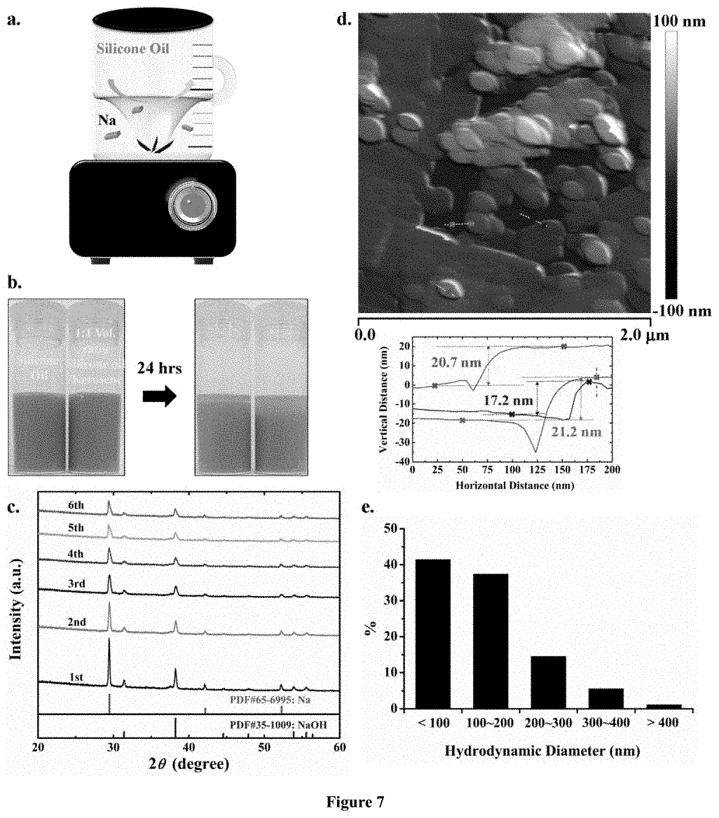

Large pieces of bulk sodium metal and silicone oil were purchased from Sigma-Aldrich and used as received. Three grams of sodium metal were mixed with 150 mL silicone oil, which has a viscosity of 45.0-55.0 cP at 25° C. As shown in FIG. 1a, the mixture was then transferred into the jar of a commercially available Biolomix G5200 household blender. For the first three minutes, the system was subjected to the lowest blending power to avoid strong collisions between the large pieces of sodium and the blender walls at high speed. Subsequently, the blender was used at its full strength for another 12 minutes. The entire process involves 15 minutes of blending with some additional cooling time after every five minutes of work to prevent the blender jar from cracking at high temperature. The final suspension displays a consistent grey color as shown in FIG. 7b, indicating that the size of the sodium is reduced to the nano to micro scale. Colloidal stability of the nanofluid was evaluated since it is an important parameter for engineering screening and design. As indicated by the high Hamaker constants of metals, the van der Waals (VDW) interaction between two identical metal nanoparticles in a nonconductive medium would result in strong attraction between the nanoparticles, leading to an unstable system. According to theoretical kinetics of nanoparticles and/or nanosheets aggregation and Stoke's law for particle settling, the high viscosity of silicone oil and the density similarity between silicone oil and sodium metal contribute to delay such a phenomenon, helping to “kinetically stabilize” the system (Gambinossi, F.; Mylon, S. E.; Ferri, J. K., Adv. Colloid Interface Sci. 222, 332-349 (2015); Johnson, C. P.; Li, X. Y.; Logan, B. E., Environ. Sci. Technol. 30, 1911-1918 (1996).

As shown in FIG. 7 (b), after 24 hours of settling, the pure silicone oil suspension with a higher viscosity exhibits greater stability than that with viscosity tuned by using kerosene of 1.8 cP viscosity at the same nanomaterial concentration, but both systems have an adequate time window for surface injection before becoming too unstable. The silicone oil suspension can even maintain colloidal stability for more than one week. It is also possible to further increase the stability by enhancing the system viscosity, such as by adding a soluble polymer.

X-ray powder diffraction (XRD) analysis was employed to confirm the synthesized sodium nanomaterials. When XRD testing began, it was found that the sodium nanomaterials in the silicone oil would immediately react with the environment since the signature white color of sodium hydroxide was observed. This is consistent with the XRD patterns displayed in FIG. 7 (c) which show that both Na and NaOH were detected. However, by comparing the maximum peak values of Na and NaOH, it is clear that Na is the majority component. To further demonstrate that X-rays could activate the reaction, multiple rounds of XRD testing was performed in order to calculate the ratio of the maximum peak values of Na and NaOH for each test, which was normalized based on the measurement results of the first test (see FIG. 10). As predicted, the greater the exposure to X-rays, the lower the ratio of Na to NaOH becomes. To obtain the nanoparticles and/or nanosheets morphology and size information, atomic force microscopy (AFM) was used to capture an image of the sodium nanomaterials in silicone oil under a contact mode condition at room temperature. In order to perform AFM measurements in such viscous silicone oil maintaining the nanofluid as a film of less than 10 microns thick was found to be the key to obtaining a good image and eliminating viscous drag. As shown in FIG. 7d, the sodium nanomaterials exhibit a sheet-like structure, which is resulted from the shear force generated by the blender, and the morphology of sodium nanoparticles and/or nanosheets is controlled by the forces acting on the bulk sodium. The majority of the nanosheets have lateral dimensions of around 200 nm for the longer length and less than 100 nm for the shorter one. In the AFM imaging process, it was also found that the nanosheets have a strong tendency to aggregate into larger slices, from 300 nm in size to even much larger, due to strong VDW attraction. However, measurements of three different single sheets show that they have nearly the same thickness, of about 20 nm (such height profiles are shown in FIG. 7d). The size distribution of the nanosheets was further investigated by light scattering, as shown in FIG. 7e, which displays a polydispersity in which most of the particles are less than 200 nm in diameter. This is in a good agreement with the results from the AFM.

### Example 3: Sand-Pack Experiments for Extra-Heavy Oil Recovery

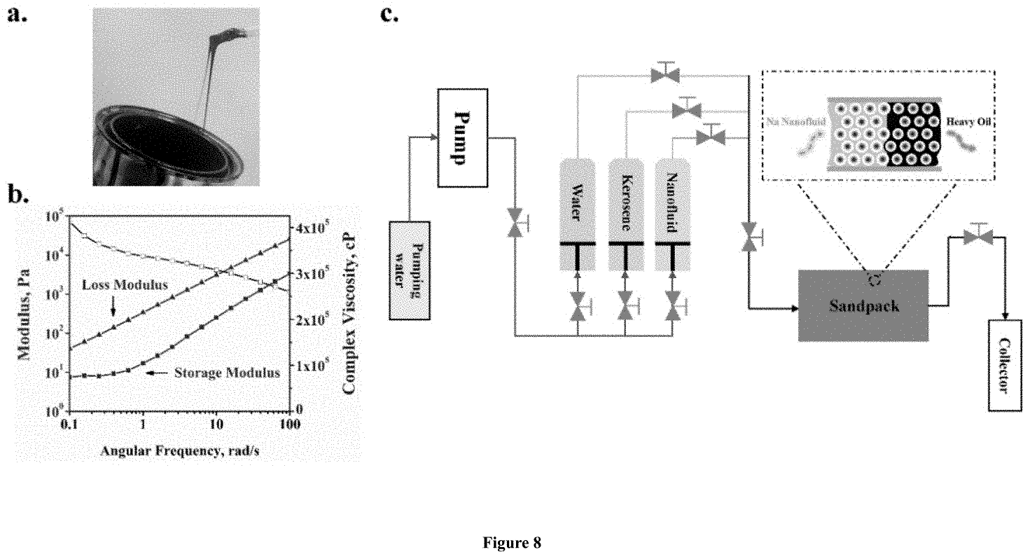

The highly viscous crude oil used for the following experiments is shown as photographed in FIG. 8 (a). Since viscoelasticity is characteristic of this extra-heavy crude oil, a rotational rheometer was employed to understand its behavior at 25° C. As shown in FIG. 8 (b), both moduli depend on the frequency, and the loss modulus exceeds the storage modulus, showing typical liquid behavior. Therefore, the shear and complex viscosities coincide no matter which part of the flow curve is examined for comparison (Ilyin, S. O.; Strelets, L. A., Energy Fuels 32, 268-278 (2018)). Based on this analysis, the viscosity of the crude oil is over 400,000 cP, placing it in the category of extra-heavy oil. It is exceedingly difficult to use porous rocks to perform the recovery tests without damaging the oil's chemical properties. Sand-pack flow experiments, as schematically illustrated in FIG. 8 (c), were therefore conducted using spherical zirconium oxide (ZrO₂) balls with a uniform diameter of 0.5025 cm as packing sands. The dimensions of the packed column were chosen as length of 7 cm and diameter of 2.765 cm (Dan Luo, Zhifeng Ren, Synthesis of sodium nanoparticles for promising extraction of heavy oil, Materials Today Physics, Volume 16, 2021, 100276.).

Porosity and Permeability Calculations: with the assumption of ideal packing, the porosity and permeability can be calculated using empirical equations (Dixon, A. G., Can. J. Chem. Eng. 66, 705-708 (1988), Li, Y. C.; Park, C. W., Ind. Eng. Chem. Res. 37, 2005-2011 (1998)): for spherical particles of identical size not mixed with extra-heavy oil, the porosity Ø₁ is calculated by

$${∅}_{1} = 0.4 + 0.05 ( \frac{{d}_{p}}{{d}_{t}} ) + 0.412 {( \frac{{d}_{p}}{{d}_{t}} )}^{2} , \qquad {d}_{p} / {d}_{t} \leq 0.5 ,$$

where dₚ is the diameter of a spherical particle while dₜ is the diameter of the packed column. When extra-heavy oil is mixed with the particles, the porosity Ø₂ is given as

$${∅}_{2} = \frac{{V}_{column} * {∅}_{1} - {m}_{o} \text{/} {ρ}_{o}}{{V}_{column}} ,$$

where V_{column} is the volume of the packed column, mₒ is the mass of the extra-heavy oil, and ρₒ is the density of the extra-heavy oil. According to the Kozeny-Carman correlation, the permeability k is given as

$$k = \frac{{∅}_{2}^{3} {d}_{p}^{2}}{150 {( 1 - {∅}_{2} )}^{2}} .$$

Based on the above equations, the physical properties of the sand-pack columns used for the five experiments are displayed below in Table 3. The recovery performance of a single-stage sodium nanofluid injection was first tested with different nanofluid concentrations at 25° C. Since water flooding is usually implemented after primary recovery, utilizing natural pressure difference, it was also injected here first as well for comparison. To delay the reaction between the sodium nanofluid and the pre-existing water, a small amount of Crown 1-K kerosene was used as a pre-flush fluid prior to injection of the nanofluid. After finishing the nanofluid injection, kerosene was also used as a post-flush fluid to clean the residue in the pipeline, followed by another water injection to trigger the reaction. The detailed injection procedures, rates, and material amounts are provided herein, and the column porosity and permeability are provided in Table 3. For each sand-pack test, the sodium nanomaterials were dispersed in a solvent with 1:1 volume ratio of silicone oil to kerosene. The recovery efficiency is calculated as:

$$efficiency , \% = ( 1 - \frac{mass of sandpack column after injection}{original mass of sandpack column} ) \times 100 \% .$$

As indicated by the recovery results provided in Table 1, pure water injection does not play any role in this highly viscous oil recovery. This agrees with the usual extremely low recovery performance by water flooding in actual extra-heavy oil reservoirs. However, significant recovery improvement was detected when sodium nanofluid was used at each tested concentration.

TABLE 1
Extra-heavy oil recovery performance by single-stage nanofluid
injection with different concentrations at 25° C.

| | | Concentration | Recovery | |
|---|---|---|---|---|
| | As-received | of sodium | efficiency | |
| | extra-heavy | nanosheets in | of water | Recovery |
| | oil in column, | 5 mL nanofluid | injection before | efficiency of |
| Test | gram | injection, mg | nanofluid, % | nanofluid, % |
| 1 | 9.99 | 200 | 0.0 | 30.7 |
| 2 | 9.50 | 400 | 0.0 | 51.9 |
| 3 | 8.79 | 800 | 0.0 | 40.1 |

In observing the change in recovery efficiency by tuning the amount of nanomaterials, it is interesting that increasing the nanomaterial concentration does not always further increase the efficiency, which is different from our assumption that more sodium nanomaterials would generate more heat for greater reduction of viscosity, allowing the oil to flow more easily. The explanation for these results is discussed in the section below on the interactions between the oil and the nanofluid. In addition, the control experiment using only solvent without nanomaterials for recovery is listed as Test 5 in Table 2, which shows that it can only achieve 6.2% recovery efficiency in the first stage. This comparison clearly demonstrates that sodium nanosheets play a major role in the recovery of this extra-heavy oil.

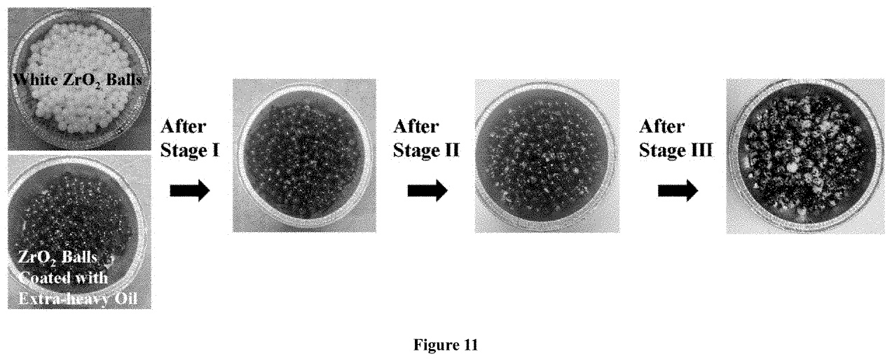

To further develop its potential for recovery, a multi-stage injection of sodium nanofluid, was performed and the results of which are shown as Test 4 in Table 2. Based on the results from the single-stage injection experiments, the conditions in Stage I of Test 4 are the same as those of Test 2, using 400 mg sodium nanosheets. This was followed by another two stages of alternating injections of water and 1 mL nanofluid containing 100 mg sodium nanosheets. Detailed information regarding the injection procedures, as well as those for the solvent-only control test, are provided in the Experimental Section below. Table 2 shows that multi-stage injections can further enhance the recovery efficiency even for the case of only solvent. Significantly distinguished from the multi-stage solvent-only injections, three stages of sodium nanofluid injections resulted in a very high recovery efficiency, i.e., 81.6%, which is also indicated by the surface color change of the ZrO₂ balls from shiny black to their original white (see FIG. 11). Generally, in comparison with a single-stage injection, the distribution of fluids by multi-stage injections in the sand-pack column is different, even when the same amount of material is used.

TABLE 2
Extra-heavy oil recovery performance by multi-
stage nanofluid injections at 25° C.

| | As-received | Recovery | Stage | Stage | Stage |
|---|---|---|---|---|---|
| | extra-heavy | efficiency of | I | II | III |
| | oil in | water injection | effi- | effi- | effi- |
| | column, | before nanofluid, | ciency, | ciency, | ciency, |
| Test | gram | % | % | % | % |
| 4 | 9.38 | 0 | 53.9 | 71.6 | 81.6 |
| (nano- | | | | | |
| fluid) | | | | | |
| 5 | 10.17 | 0 | 6.2 | 11.3 | 15.5 |
| (solvent) | | | | | |

### Interactions Between Extra-Heavy Oil and Nanofluid

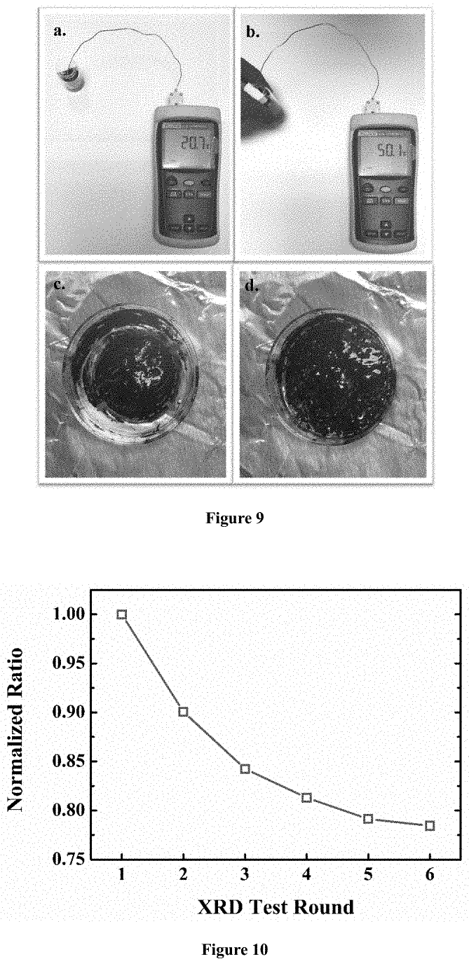

Investigating the interactions between the oil and the sodium nanofluid is fundamental to understanding the mechanisms underlying oil recovery by these reactive nanosheets. It is well known that an alkali metal reacting with water is a strong exothermic process and could lead to an explosion.³¹ The change of enthalpy for this type of reaction between sodium and water is −184 kJ/mol at standard conditions. In a straightforward way, such released heat could be used to increase the temperature of extra-heavy oil. To demonstrate this effect, an apparatus was built, and the results are shown in FIG. 9 ((a) and (b)). Initially, 1 gram extra-heavy oil was mixed with 40 mg sodium nanosheets dispersed in 0.5 mL pure kerosene. A thermometer was placed into the extra-heavy oil, displaying its initial temperature as 20.7° C. Triggered by 0.3 mL water injection, a temperature difference of nearly 30° C. can be achieved even in such an open system. Ideally, if there is no heat generation by sodium hydroxide dissolution in water or heat loss through convection by hydrogen gas, conduction by the glass vial, etc., the calculated temperature difference can reach 85° C. as shown in the Supplementary Information. In addition to the rise in temperature, another easily observable phenomenon was the generation of bubbles in the vial due to the production of hydrogen gas. Therefore, another demonstration was performed to show the effect of such gas production on the extra-heavy oil. By mixing 1 gram extra-heavy oil with sodium nanofluid as shown in FIG. 9 (c), sodium nanosheets were evenly distributed throughout the extra-heavy oil since the solvent (kerosene/silicone oil at 1:1 volume ratio) could dissolve this crude oil. Following injection of water, hydrogen gas was generated (see Video 51 in the Supplementary Information), and the extra-heavy oil began to swell.

After a noticeably short time, the oil expanded to the edge of the Petri dish as shown in FIG. 9 (d). In a confined system or in rock pores at reservoir conditions, the generation of hydrogen gas directly supplies the reservoir with energy for oil recovery. The swelling of the extra-heavy oil also contributes to its recovery. In addition, it is also possible that hydrogen gas could be miscible with the oil once the local pressure is over the minimum miscibility pressure (MMP), like the carbon dioxide, flue gas, nitrogen gas, methane, etc. used in miscible flooding. Using this miscibility, the viscosity of the extra-heavy oil could also be largely reduced. It must also be mentioned here that the alternating injections of sodium nanofluid and water in the multi-stage mode in fact generate water-alternating-gas (WAG) flooding, which has been demonstrated to significantly modify sweeping efficiency in practice in the field. Since the recovery efficiency is equal to the product of the sweeping efficiency and the microscopic displacement efficiency, the improved sweeping efficiency is one of the main reasons that multi-stage injections can achieve higher efficiency than the single-stage mode, even when the same amount of material is injected (Shah. A.; Fishwick, R.; Wood, J.; Leeke, G.; Rigby, S.; Greaves, M., Energy Environ. Sci. 3, 700-714 (2010); Zhou, X.; Yuan, Q. W; Peng, X. L.; Zeng, F. H.; Zhang, L. H., Fuel 215, 813-824 (2018); Al-Bayati, D.; Saeedi, A.; Myers, M.; White, C.; Xie, Q.; Clennell, B., J. CO₂ Util. 28, 255-263 (2018)).

Another important product resulting from the reaction between the sodium nanosheets and the water is sodium hydroxide since it has been recognized to react with organic acids in crude oil to in situ generate surfactants, which has been put into practice in actual oil fields for many years. As a result, several oil recovery mechanisms have been identified, including the lowering of interfacial tension (IFT), emulsification of the oil, and wettability alteration. These three mechanisms are believed to increase the microscopic displacement efficiency, while emulsification can further improve the macroscopic sweeping efficiency by diverting flow (Mason, P. E.; Uhlig, F.; Vaněk, V.; Buttersack, T.; Bauerecker, S.; Jungwirth, P., Nat. Chem. 7, 250-254 (2015); Zhang, H. Y.; Dong, M. Z.; Zhao, S. Q., Energy Fuels 26, 3644-3650 (2012); Pei, H. H.; Zhang, G. C.; Ge, J. J.; Jin, L. C.; Liu, X. L., Energy Fuels 25, 4423-4429 (2011); Kumar, S.; Mandal, A., Appl. Surf. Sci. 372, 42-51 (2016)).

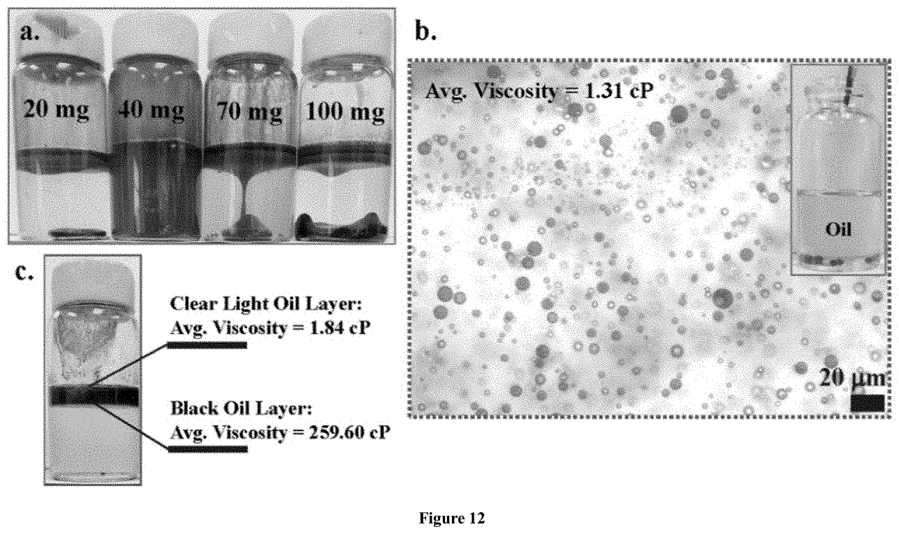

Since there is an optimal alkaline concentration at which the IFT reaches a minimum, a series of experiments as shown in FIG. 12 (a) were conducted to investigate the effect of nanosheet concentration on the interactions among the extra-heavy oil, water, and sodium nanosheets. 1 g of extra-heavy oil was mixed with different concentrations of sodium nanosheets dispersed in 0.5 mL silicone/kerosene (1:1 volume ratio), followed by injection of 0.3 mL water to trigger the reaction at room temperature. After some time, 9.7 mL water was injected, and the fluid system was shaken by hand. All the chosen concentrations showed the ability to emulsify the extra-heavy oil, but the emulsion remained stable for at least one week at room temperature only in the sample with 40 mg nanosheets. The emulsion type was determined to be oil-in-water since the emulsion droplets maintain their shapes in the oil phase as shown in the inset of FIG. 12 (b). An optical microscope was further employed to measure the emulsion size. As shown in FIG. 12 (b), the emulsion diameters range from several microns up to 15 μm. In fact, there are two types of emulsions. The transparent droplets observed in FIG. 12 (b) are kerosene or silicone oil used as solvent for the nanofluid while the dark, opaque droplets are the extra-heavy oil. The emulsified system exhibits extremely low viscosity, i.e., 1.31 cP, as the water is the bulk phase. For the most stable emulsion found here, formed using 40 mg nanosheets, the sodium hydroxide concentration after completion of the reaction is about 0.69 wt %, which is very close to the reported optimal NaOH concentration to achieve a minimum IFT (Zhao, C. M.; Jiang, Y. L.; Li, M. W.; Cheng, T. X.; Yang, W. S.; Zhou, G. D., RSC Adv. 8, 6169-6177 (2018).

To measure the oil viscosity, the fluid was demulsified in the system by adding 2 wt % NaCl and maintaining the system at 50° C. overnight. After cooling the system down to 25° C., it exhibited a phase separation as shown in FIG. 12 (c). The top layer is colorless light oil with measured viscosity of 1.84 cP and the bottom layer is water. The as-received extra-heavy oil was modified through interactions with the sodium nanofluid and accumulated in the middle layer. Its viscosity was sharply reduced to 259.60 cP from its initial viscosity of over 400,000 cP. The above results show that the optimal concentration of nanofluid for the extra-heavy oil recovery was found in the previous sand-pack experiments.

### Experimental Section

Materials.

The extra-heavy oil was provided by a commercial oil company. Large sodium pieces were purchased from Sigma-Aldrich and stored in kerosene with >99.8% purity. Silicone oil with a viscosity of 45.0-55.0 cP (25° C.) and a density of 0.963 g/mL (25° C.) and sodium chloride of ACS reagent grade were also purchased from Sigma-Aldrich. Kerosene of grade K-1 used in all experiments was distributed by Crown and purchased from Walmart. All the chemicals were used as received. Water used in all experiments was deionized and has a resistivity of 18.2 million ohm-cm.

Instruments and Characterization.

A Biolomix household blender (model number G5200) was used to produce the mixtures of sodium nanosheets and silicone oil. It has a maximum of 2200 W motor power, allowing its mixing blades to reach up to 45,000 RPM. A Panalytical X'pert PRO diffractometer was employed to conduct X-ray diffraction (XRD) measurements at atmosphere. The samples analyzed by XRD are the suspensions of sodium nanosheets dispersed in silicone oil. As the measurements were taken, it was clear that X-rays activate the sodium nanosheets to react with water in the atmosphere since white crystal powder and bubbles appeared, indicating the presence of sodium hydroxide and hydrogen gas, respectively. The atomic force microscope (AFM) used in the experiment is a Multimode 8 system under a contact mode condition with NanoScope 8.15 control software. The AFM probes used are MLCT probes from Bruker Nano. The spring constant of the AFM cantilever is 0.02 N/m. The low-concentration sodium nanosheet sample was prepared in silicone oil at room temperature.

A 2 μl drop of the sample was applied onto a newly cleaved mica (Ted Pella Inc.) surface, and a lens paper (Thermal Fisher Inc.) was immediately used to remove excess silicone oil from the mica to maintain a maximum oil-film thickness of less than 10 μm. A quick image scan was used with a frequency of 3 Hz. In the AFM imaging process, it was noticeable that the sodium nanosheets have a strong tendency to aggregate into a larger slice. The size distribution of the nanosheets was further detected by the light scattering method using a Malvern NanoSight NS300. The nanosheets were dispersed in kerosene at a very dilute concentration for light scattering measurements. A TA Instruments rheometer was used to probe the viscoelasticity of the as-received extra-heavy oil. The oil was first placed on the parallel plate, followed by slowly lowering the top plate until the gap was fully filled. An amplitude sweep was conducted to determine the linear viscoelastic region. A frequency sweep from 0.1 to 100 rad/s was then completed using a strain in the linear region at room temperature. The changes in storage and loss moduli, as well as in the complex viscosity, with frequency could thus be obtained. The viscosity of the extra-heavy oil following the reaction with sodium nanofluid was measured using a TQC Sheen cone and plate viscometer. The size of the emulsion droplets was observed using an optical microscope.

Sand-Pack Experiments.

The sand-pack flow system mainly consists of a pump, a sand-pack column holder, a collector, and three containers that are used to store deionized water, kerosene, and sodium nanofluid. The sands used in all experiments are white zirconium oxide (ZrO₂) balls with a diameter of 0.5025 cm. The sands were evenly mixed with certain amounts of extra-heavy oil. The packed column is 7 cm in length and 2.765 cm in diameter. The two injection modes, single-stage, and multi-stage, were tested to evaluate the extra-heavy oil recovery performance at 25° C.

Single-Stage Injection.

Three different concentrations of sodium nanofluid were used in the tests, including 200 mg, 400 mg, and 800 mg sodium nanosheets in 5 mL solvent (silicone oil/kerosene at 1:1 volume ratio). Following preparation of the sand-pack column, water was first injected at 0.05 mL/min until no oil came out, followed by injecting 1 mL kerosene as the pre-flush liquid at a higher rate, i.e., 0.5 mL/min. Sodium nanofluid was then injected at 0.1 mL/min. This was followed by a post-flush fluid of 1 mL kerosene injected to displace any possible residue nanofluid in the pipeline. To trigger the reaction, water was again injected at 0.05 mL/min until no oil came out.

TABLE 3
Porosity and permeability of each sand-pack column.

| Test | Porosity, % | Permeability, D |
|---|---|---|
| 1 | 19.7 | 2.00 × 10³ |
| 2 | 21.3 | 2.63 × 10³ |
| 3 | 18.5 | 1.60 × 10³ |
| 4 | 19.9 | 2.07 × 10³ |
| 5 | 18.1 | 1.49 × 10³ |

### Temperature Difference Calculations

At standard conditions, the heat released by sodium reacting with water is −184 kJ/mol. Our experimental system initially consisted of 1-gram extra-heavy oil and 40 mg sodium nanosheets dispersed in 0.5 mL pure kerosene, followed by injection of 0.3 mL water. Without considering any heat loss or sodium hydroxide dissolution in the water, ideally obtain the following equation:

$$184 * \frac{{m}_{Na}}{{M}_{Na}} = Δ T * ( {C}_{po} * {m}_{o} + {C}_{pw} * {m}_{w} + {C}_{pk} * {m}_{k} + {C}_{pNaOH} * {m}_{NaOH} + {C}_{{pH}_{2}} * {m}_{{H}_{2}} ) ,$$

where m_{Na} is the mass of sodium, 40 mg; M_{Na} is the molecular weight of sodium, 23 g/mol; ΔT is the temperature difference in ° C.; Cₚₒ is the specific heat capacity of extra-heavy oil, 1.69 kJ/(kg*° C.);³ mₒ is the mass of extra-heavy oil, 1 gram; C_{pw} is the specific heat capacity of water, 4.19 kJ/(kg*° C.);⁴ m_{w} is the mass of the water reaction, 0.269 gram here; Cₚₖ is the specific heat capacity of kerosene, 2.01 kJ/(kg*° C.);⁴ C_{pNaOH} is the specific heat capacity of NaOH 59.92 J/(mol*° C.);⁵ m_{NaOH} is the mass of NaOH; C_{pH}_{₂} is the specific heat capacity of H₂, 14.31 kJ/(kg*° C.);⁶ m_{H}_{₂} is the mass of H₂. All the specific heat data used are at 25° C. As a result, the temperature difference can reach to about 85° C.

Multi-Stage Injection.

Based on the results from the single-stage injection experiments, 5 mL sodium nanofluid containing 400 mg sodium nanosheets as the first stage of the multi-stage injection experiment were used. The procedures of the first stage are the same as those for the single-stage mode. The first stage was followed by injection of 1 mL sodium nanofluid containing 100 mg sodium nanosheets and subsequent injection of water at a rate of 0.05 mL/min until no more oil came out, completing the second stage. Finally, another 1 mL sodium nanofluid containing 100 mg sodium nanosheets was injected, followed by water injection at 0.05 mL/min until no more oil came out. In total, three stages of nanofluid injections were conducted. Furthermore, a control experiment was also performed, in which the same procedures were used as in the three-stage experiment, except that the sodium nanofluid was replaced by the solvent used for dispersing the sodium nanosheets.

In conclusion, disclosed herein is a fast and inexpensive method to synthesize nanosheets for the reduction of viscosity of solutions, such as but not limited to heavy oil, for reduction of viscosity therefore and subsequent extraction from a body, for example a well formation, or a hydrocarbon bearing formation. Sodium nanosheets may be simply produced by using a household blender. A colloidally and chemically stable sodium nanosheet fluid was formed and demonstrated in situ recovery of highly viscous crude oil at room temperature. By investigating the interactions among extra-heavy oil, sodium nanofluid, and water, multiple benefits were revealed to contribute to such oil recovery and are based on the chemical reaction between alkali metal and water. In sand-pack experiments, it was found that a multi-stage injection mode is superior to a single-stage mode in the recovery since higher sweeping efficiency can be achieved. However, no two crude oil deposits are exactly the same, and reservoir conditions vary widely around the world. Optimal concentrations of sodium nanofluid in actual oil fields would therefore vary. The nanofluids disclosed herein are applicable to address recovery issues for conventional light oil due to its benefits of gas generation, IFT reduction, emulsification of crude oil, etc. It may also have potential for extracting oil from oil sands. In addition, it is possible to mix the sodium nanosheets with other chemicals commonly used in oil fields, such as surfactants and polymers, for other applications. More importantly, sodium resources are abundant and the method to make sodium nanosheets is scalable and environmentally friendly. Massive studies on the application of nanotechnology in petroleum industry especially for EOR have been done and shown promising results. Nano-EOR is proposed to substitute the existing chemical EOR for improving the oil recovery efficiency with several advantages: (1) Nanoparticles and/or nanosheets can improve the fluid performance by only using small amount of materials, (2) improvement in heat and mass transfer lead to the possible application in high-temperature condition, (3) high flexibility for combining with other materials such as surfactant and polymer. Various types of Nanoparticles and/or nanosheets (organic and inorganic) are confirmed to be able to significantly increase the oil recovery. Nanoparticles and/or nanosheets can improve the oil recovery through several mechanisms such as interfacial tension reduction, wettability alteration, disjoining pressure, and viscosity control. Some parameters, like nanoparticles and/or nanosheets concentration, size, temperature, wettability, and salinity, are proven to affect the performance of nano-EOR.

We claim:

1. A composition for reducing the viscosity of oil, comprising:
a reactive particle;
a solvent and/or a polymer; and
wherein said reactive particle is between 1 nm and 1000 microns in size and is dispersed within said solvent, and wherein said composition reacts with water and oil to lower oil viscosity and facilitate extraction from a body.

2. A composition for reducing the viscosity of heavy oils for ease of extracting viscous heavy oil, comprising:
a reactive particle;
a solvent; and
a polymer;
wherein said metal particle is between 1 nm and 1000 microns in size and is dispersed within said solvent, and wherein said composition reacts with water and oil to lower oil viscosity and facilitate extraction from an underground formation.

3. The composition of claim 1, wherein said reactive particle comprises at least one of VO, Ni, Fe, Li, Na, K, Rb, Cs, Mg, Ca, Sr, Ba, B, Al, Ga, an oxide, sulfate, nitride, or phosphide thereof.

4. The composition of claim 1, wherein said reactive particle is a size reduced particle wherein said particle is reduced in size by a mechanic method, wherein said mechanical method is ball milling, or blending.

5. The composition of claim 1, wherein said solvent is selected from hexane, heptane, toluene, liquid wax, or any organic solvent which can prevent the particles from contact with water and oxygen.

6. The composition of claim 1, wherein said polymer is a hydrophobic polymer, and wherein said polymer stabilizes said reactive particle dispersed within said solvent.

7. The composition of claim 1, wherein the polymer has a melting point of about 50° C.

8. The composition of claim 6 wherein the polymer is low viscous engine oil.

9. A method of making a composition for reacting with viscous heavy oil;
ball milling or blending a metal particle and producing metal particles, wherein said ball milled, bead milled, or blended metal particles are between 1 nm and 1000 microns in size;
dispersing said ball milled, bead milled or blended metal particles in a solvent and forming a dispersion; and
mixing a polymer with said dispersion to form a polymer stabilized dispersion.

10. A method of reducing the viscosity of oil comprising:
adding a composition comprising:
a highly reactive metal particle;
a solvent and/or a polymer to an oil of a first viscosity; and
reacting said composition within said oil and reducing the viscosity of said oil to produce an oil with a lower viscosity.

11. A method of extracting oil from a formation comprising:
adding a composition comprising:
a highly reactive metal particle;
a solvent and/or a polymer to a formation comprising an oil of a first viscosity; and
reacting said composition within said oil and reducing the viscosity of said oil to produce an oil with a lower viscosity and extracting said oil with the lower viscosity from said formation.

12. The method of claim 10, wherein said oil is heavy or extra heavy oil.

13. The method of claim 10, wherein said highly reactive metal particle is ball milled, bead mill or blended, and is between 1 nm and 1000 microns in size

14. The method of claim 10, wherein said composition is injected into an oil well or underground formation comprising oil or oil transport pipe.

15. The method of claim 10, wherein said composition is injected into an oil well or underground formation by means of a one injection, or multiple injections.

16. The method of claim 10, wherein the reacting further comprises exothermically reacting with water comprised within said formation and reducing the viscosity of said oil.

17. The method of claim 15, wherein reacting further comprises forming of metal hydroxides which further react with organic acids comprising in the heavy oil, and forming in situ surfactants, wherein said surfactant lower oil/water interfacial tension.

18. The method of claim 15, wherein reacting further comprises the forming of hydrogen gas in situ of the well, increasing reservoir energy, and reducing viscosity of the heavy oil in situ of the well.

19. The method of claim 15, wherein reacting upgrades oil quality by inducing hydrogenation reactions.

20. The method of claim 9, wherein said adding is by injection, or under pressure, and wherein said adding may occur after an injection of water, or before an injection of water into said well or formation.

21. The method of claim 10, wherein said adding is by injection, or under pressure, and wherein said adding may occur after an injection of water, or before an injection of water into said well or formation.

22. The method of claim 1, wherein said body is one of: a pipe, an underground formation, a hydrocarbon comprising formation.

23. The method of making a sodium nanofluid, the method comprising:
a first mixing of a sodium metal; and silicone oil, wherein said first mixing is for a first time (T1) at a first speed (S1), followed by a second mixing of said metal and oil for a second time (T2) at a second speed (S2), wherein said first and said second mixing is by a mechanical shear force; and wherein said S1<S2, and T1<T2, wherein said first and second mixing form a sodium nanofluid, and wherein said sodium nanofluid is cooled at five minute intervals during said first mixing and said second mixing.
